(19) United States
(12) Patent Application Publication
(10) Pub. No.: US 2013/0140942 A1
(43) Pub. Date: Jun. 6, 2013

(54) SPINDLE MOTOR

(71) Applicant: Samsung Electro-Mechanics Co., Ltd., Suwon (KR)

(72) Inventors: Jong Ryeol OH, Suwon (KR); Suk Ju Hong, Suwon (KR); Tae Jun Kim, Suwon (KR)

(73) Assignee: Samsung Electro-Mechanics Co., Ltd., Suwon (KR)

(21) Appl. No.: 13/688,406

(22) Filed: Nov. 29, 2012

(30) Foreign Application Priority Data
Dec. 1, 2011 (KR) 10-2011-0127477

(51) Int. Cl. H02K 57/00

(52) U.S. Cl. CPC H02K 57/006
USPC 310/261.1

(57) ABSTRACT

There is provided a spindle motor including: a shaft rotatably supported by a sleeve; and a rotor hub fixedly installed on an upper end portion of the shaft, wherein the shaft includes a burr generation suppression part formed at the upper end portion thereof in order to suppress burr generation in an inner peripheral surface of the rotor hub in the case in which the rotor hub is press-fitted to the shaft.

### CROSS-REFERENCE TO RELATED APPLICATIONS

This application claims the priority of Korean Patent Application No. 10-2011-0127477 filed on Dec. 1, 2011, in the Korean Intellectual Property Office, the disclosure of which is incorporated herein by reference.

### BACKGROUND OF THE INVENTION

1. Field of the Invention

The present invention relates to a spindle motor.

2. Description of the Related Art

In general, a small spindle motor used in a hard disk drive (HDD) is provided with a fluid dynamic bearing assembly, and a lubricating fluid such as oil is provided in a bearing clearance formed between a shaft and a sleeve of the fluid dynamic bearing assembly. Fluid dynamic pressure is generated in the oil provided in the bearing clearance when the oil is compressed, thereby rotatably supporting the shaft.

In addition, the bearing clearance is also formed by an upper surface of the sleeve and a lower surface of a rotor case coupled to the shaft to rotate together therewith. In addition, the bearing clearance formed by the upper surface of the sleeve and the lower surface of the rotor case is also provided with the lubricating fluid.

Meanwhile, the shaft includes a rotor hub installed on an upper end portion thereof in order to provide rotational force. In addition, the rotor hub is press-fitted onto the upper end portion of the shaft.

However, when the rotor hub is press-fitted onto the upper end portion of the shaft, an inner peripheral surface of the rotor hub may be scratched by a distal end portion of the shaft.

Therefore, burrs may be generated in the inner peripheral surface of the rotor hub, and as a result, an assembly defect may be generated.

Thus, the development of a structure capable of reducing the generation of burrs formed in an inner surface of the rotor hub while not reducing coupling force between the rotor hub and the shaft has been required.

### SUMMARY OF THE INVENTION

An aspect of the present invention provides a spindle motor capable of reducing damage to an inner peripheral surface of a rotor hub.

According to an aspect of the present invention, there is provided a spindle motor including: a shaft rotatably supported by a sleeve; and a rotor hub fixedly installed on an upper end portion of the shaft, wherein the shaft includes a burr generation suppression part in order to suppress burr generation in an inner peripheral surface of the rotor hub in a case in which the rotor hub is press-fitted to the shaft.

The burr generation suppression part may be formed to be rounded at an edge of the upper end portion of the shaft.

The burr generation suppression part may have an angle of inclination of 5 to 7 degrees inwardly from an outer peripheral surface of the shaft in a radial direction.

The inner peripheral surface of the rotor hub may be provided with a press-fitted part press-fitted to the outer peripheral surface of the shaft and an inclined part disposed to face the burr generation suppression part in an upper portion of the press-fitted part.

The burr generation suppression part may be formed in an upper portion of the outer peripheral surface of the shaft bonded to the press-fitted part.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor according to an embodiment of the present invention;

FIG. 2 is an enlarged view of part A of FIG. 1; and

FIG. 3 is a view illustrating an operation of the spindle motor according to the embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements maybe exaggerated for clarity, and the same reference numerals will be used throughout to designate the same or like elements.

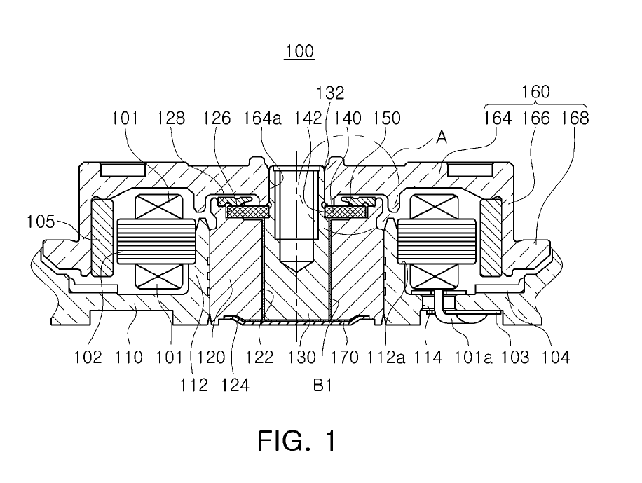

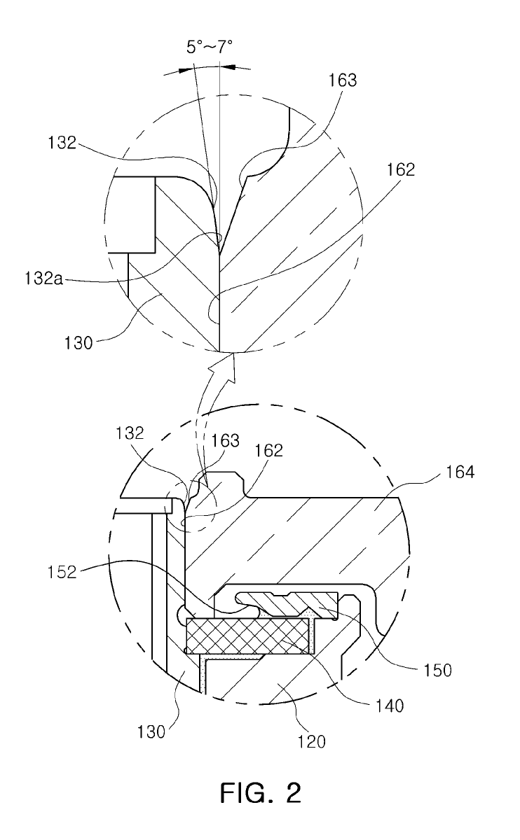

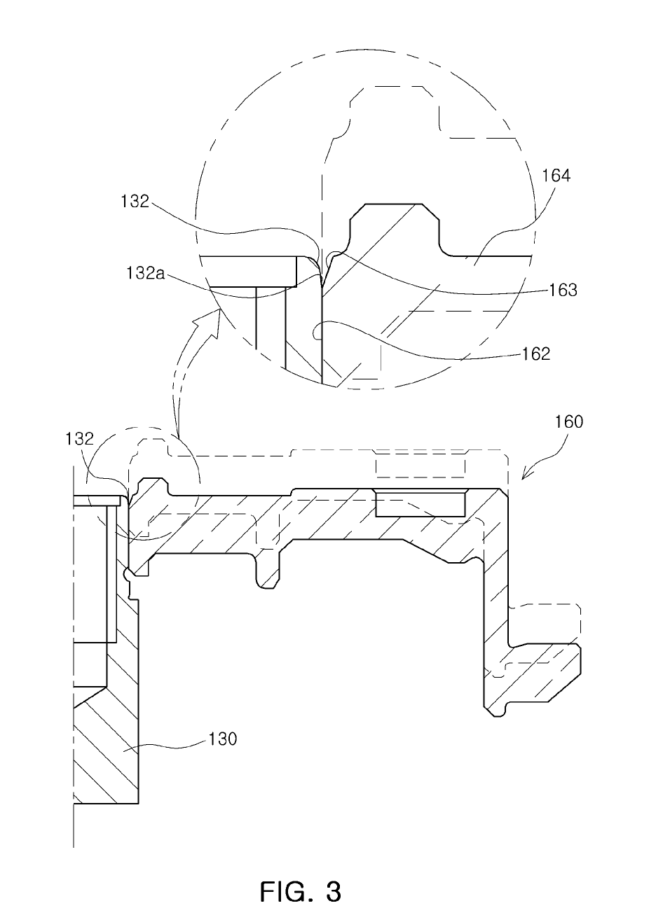

FIG. 1 is a schematic cross-sectional view showing a spindle motor according to an embodiment of the present invention; FIG. 2 is an enlarged view of part A of FIG. 1; and FIG. 3 is a view illustrating an operation of the spindle motor according to the embodiment of the present invention.

Referring to FIGS. 1 through 3, a spindle motor 100 according to an embodiment of the present invention may include, for example, a base member 110, a sleeve 120, a shaft 130, a thrust plate 140, a sealing cap 150, and a rotor hub 160.

Here, terms with respect to directions will first be defined. As viewed in FIG. 1, an axial direction refers to a vertical direction, that is, a direction from an upper portion of the shaft 130 toward a lower portion thereof or a direction from the lower portion of the shaft 130 toward the upper portion thereof, and a radial direction refers to a horizontal direction, that is, a direction from an outer peripheral surface of the rotor hub 160 toward the shaft 130 or from the shaft 130 toward the outer peripheral surface of the rotor hub 160.

In addition, a circumferential direction refers to a rotation direction along the outer peripheral surface of the rotor hub 160.

The base member 110 may include an installation part 112 having the sleeve 120 installed therein. The installation part 112 may protrude upwardly in the axial direction, and the sleeve 120 maybe insertedly installed in the installation part 112.

In addition, the installation part 112 may include a stator core 102 installed on an outer peripheral surface thereof, wherein the stator core 102 has a coil 101 wound therearound. That is, the stator core 102 may be fixedly installed by an adhesive and/or welding in a state in which the stator core 102 is seated on a seating surface 112a formed on the outer peripheral surface of the installation part 112.

Meanwhile, the base member 110 may include a lead-hole 114 formed therein so as to be disposed in the vicinity of the installation part 112. In addition, a lead part 101a of a coil 101 wound around the stator core 102 may be led from an upper portion of the base member 110 toward a lower portion thereof through the lead hole 114.

Further, a lower surface of the base member 110 may be installed with a circuit board 103 to which the lead part 101a of the coil 101 is bonded. In addition, the circuit board 103 may be a flexible circuit board.

Meanwhile, the base member 110 may include a pulling plate 104 installed thereon in order to prevent the rotor hub 160 from being excessively floated, wherein the pulling plate 104 may have an annular ring shape.

The sleeve 120 may be fixedly installed to the installation part 112 as described above. That is, an outer peripheral surface of the sleeve 120 may be bonded to an inner peripheral surface of the installation part 112 by an adhesive or the sleeve 120 may be press-fitted into the installation part 112.

Further, the sleeve 120 may include a through-hole 122 formed therein so that the shaft 130 may be insertedly installed therein. That is, the sleeve 120 may have a hollow cylindrical shape.

Meanwhile, in the case in which the shaft 130 is installed in the sleeve 120, an inner peripheral surface of the sleeve 120 and the outer peripheral surface of the shaft 130 maybe spaced apart from each other by a predetermined interval to thereby form a bearing clearance B1 therebetween. In addition, this bearing clearance B1 may be filled with a lubricating fluid.

In addition, the sleeve 120 may include a dynamic pressure groove (not shown) formed in the inner surface thereof, wherein the dynamic pressure groove generates fluid dynamic pressure by pumping the lubricating fluid provided in the bearing clearance B1 at the time of rotation of the shaft 130.

In addition, the sleeve 120 may include a cover member 170 installed on a lower end portion thereof in order to prevent the lubricating fluid filled in the bearing clearance B1 from being leaked downwardly. That is, the sleeve 120 may include a depression groove 124 depressed upwardly at the lower end portion thereof so that the cover member 170 may be installed on the lower end portion thereof.

Meanwhile, the sleeve 120 may include an insertion groove 126 formed on an upper end portion thereof, wherein the insertion groove 126 includes the thrust plate 140 inserted thereinto and a bonding groove part 128 formed on an outer side thereof so that the sealing cap 150 is fixedly installed thereon.

The shaft 130 may be rotatably installed in the sleeve 120. That is, as described above, the shaft 130 maybe inserted into the through-hole 122 of the sleeve 120 and may be installed such that an upper end part of the shaft 130 protrudes upwardly of the upper end of the sleeve 120.

Further, the shaft 130 may include the thrust plate 140 and the rotor hub 160 sequentially installed on an upper end portion thereof. That is, the thrust plate 140 and the rotor hub 160 may be installed on the shaft 130 so that the rotor hub 160 may be disposed on an upper portion of the thrust plate 140.

In addition, the shaft 130 may have a burr generation suppression part 132 formed at the upper end portion thereof. In addition, the burr generation suppression part 132 may be formed to be rounded at an edge of the upper end portion of the shaft 130.

In addition, the burr generation suppression part 132 may be formed to have an angle of inclination of 5 to 7 degrees from the outer peripheral surface of the shaft 130 in the radial direction.

A detailed description of the burr generation suppression part 132 will be provided below.

The thrust plate 140 may be fixedly installed on the shaft 130 so as to be disposed on the upper portion of the sleeve 120. That is, in the case in which the shaft 130 is installed in the sleeve 120, the thrust plate 140 may be inserted into the insertion groove 126 formed on the upper end portion of the sleeve 120. To this end, the thrust plate 140 may be fixedly installed on the upper end portion of the shaft 130.

Meanwhile, a thrust dynamic pressure groove (not shown) for generating fluid dynamic pressure at the time of rotation of the thrust plate 140 may be formed in at least one of a lower surface of the thrust plate 140 and a bottom surface of the insertion groove 126.

In addition, the thrust plate 140 may have an annular ring shape in which an installation hole 142 is formed so that the shaft 130 may penetrate therethrough.

The sealing cap 150 may be fixed to the sleeve 120 and may have an inclined surface 152 so as to form a liquid-vapor interface (that is, an interface between the lubricating fluid and air) together with the thrust plate 140.

Meanwhile, the inclined surface 152 may be formed on a lower surface of the sealing cap 150, and the interface between the lubricating fluid and the air, that is, the liquid-vapor interface may be disposed in a space between the inclined surface 152 and an upper surface of the thrust plate 140.

The rotor hub 160 may be fixedly installed on the upper end portion of the shaft 130. An inner peripheral surface of the rotor hub 160 may be provided with a press-fitted part 162 press-fitted to the outer peripheral surface of the shaft 130 and an inclined part 163 disposed to face the burr generation suppression part 132 at an upper portion of the press-fitted part 162.

In addition, the burr generation suppression part 132 maybe formed in an upper portion of the outer peripheral surface of the shaft 130 bonded to the press-fitted part 162.

That is, in the case in which the rotor hub 160 is press-fitted to the upper end portion of the shaft 130, the press-fitted part 162 of the rotor hub 160 may be press-fitted to the upper end portion of the shaft 130. In addition, the burr generation suppression part 132 may be disposed to face the inclined part 163.

Therefore, a reduction in coupling force between the rotor hub 160 and the shaft 130 may be suppressed, and burr generation in the inner peripheral surface of the rotor hub 160 may be reduced by the burr generation suppression part 132, at the same time.

In addition, since the burr generation suppression part 132 may be formed to have the angle of inclination of 5 to 7 degrees from the outer peripheral surface of the shaft 130 in the radial direction, burr generation by a distal end portion 132a of the burr generation suppression part 132 may be reduced.

That is, in the case in which the burr generation suppression part 132 has an angle of inclination wider than the above range, the burr may be generated in the inner peripheral surface of the rotor hub 160 by the distal end portion 132a of the burr generation suppression part 132.

Meanwhile, the rotor hub 160 may include a body 164 having a disk shape, a magnet coupling part 166 extended downwardly from an edge of the body 164 in the axial direction, and a disk seating part 168 extended from the magnet coupling part 166 in the radial direction and having a disk seated thereon.

The body 164 may include a mounting hole 164a in order to be fixedly installed to the shaft 130, wherein the mounting hole 164a may be formed in a central portion of the body 164.

Meanwhile, the magnet mounting part 166 may have a driving magnet 105 installed on an inner surface thereof, wherein the driving magnet 105 may be disposed to face a front end of the stator core 102 having the coil 101 wound therearound. In addition, the driving magnet 105 may have an annular ring shape and be a permanent magnet generating magnetic force having a predetermined strength by alternately magnetizing an N pole and an S pole thereof in the circumferential direction.

Here, rotational driving of the rotor hub 160 will be schematically described. When power is supplied to the coil 101 wound around the stator core 102, driving force capable of rotating the rotor hub 160 may be generated by electromagnetic interaction between the driving magnet 105 and the stator core 102 having the coil 101 wound therearound.

Therefore, the rotor hub 160 may rotate, such that the shaft 130 to which the rotor hub 160 is fixedly coupled may rotate together with the rotor hub 160.

As described above, in the case in which the rotor hub 160 is press-fitted to the shaft 130 including the burr generation suppression part 132, burr generation in the inner peripheral surface of the rotor hub 160 may be reduced.

In addition, since the burr generation suppression part 132 may be formed to have the angle of inclination of 5 to 7 degrees inwardly from the outer peripheral surface of the shaft 130 in direction, burr generation may be further reduced while suppressing a reduction in adhesive force between the rotor hub 160 and the shaft 130.

Hereinafter, an operation of a spindle motor according to an embodiment of the present invention will be described with reference to the accompanying drawings.

Referring to FIG. 3, in the case in which the rotor hub 160 is installed on the shaft 130, the upper end portion of the shaft 130 is inserted into the mounting hole 164a of the rotor hub 160.

In this case, since the mounting hole 164a of the rotor hub 160 has a diameter smaller than an outer diameter of the shaft 130, in the case in which the rotor hub 160 is installed on the shaft 130, the rotor hub 160 may be press-fitted thereto.

In addition, in the case in which the shaft 130 is inserted into the mounting hole 164a, since the upper end portion of the shaft 130 is provided with the burr generation suppression part 132, interference between the shaft 130 and the inner peripheral surface of the rotor hub 160 may be reduced.

That is, burr generation in the inner peripheral surface of the rotor hub 160 may be reduced by the burr generation suppression part 132.

In addition, since the burr generation suppression part 132 has the angle of inclination of 5 to 7 degrees inwardly from the outer peripheral surface of the shaft 130 in the radial direction, burr generation may be reduced while maintaining a length of the press-fitted part 162 press-fitted to the outer peripheral surface of the shaft 130.

Further, since the burr generation suppression part 132 has the angle of inclination of 5 to 7 degrees, burrs generated in the inner peripheral surface of the rotor hub 160 by the distal end portion 132a of the burr generation suppression part 132 may be reduced.

As set forth above, according to embodiments of the present invention, damage to the inner peripheral surface of the rotor hub may be reduced by the burr generation suppression part.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a shaft rotatably supported by a sleeve; and
a rotor hub fixedly installed on an upper end portion of the shaft,
the shaft including a burr generation suppression part formed at the upper end portion thereof in order to suppress burr generation in an inner peripheral surface of the rotor hub in a case in which the rotor hub is press-fitted to the shaft.

2. The spindle motor of claim 1, wherein the burr generation suppression part is formed to be rounded at an edge of the upper end portion of the shaft.

3. The spindle motor of claim 2, wherein the burr generation suppression part has an angle of inclination of 5 to 7 degrees inwardly from an outer peripheral surface of the shaft in a radial direction.

4. The spindle motor of claim 3, wherein the inner peripheral surface of the rotor hub is provided with a press-fitted part press-fitted to the outer peripheral surface of the shaft and an inclined part disposed to face the burr generation suppression part in an upper portion of the press-fitted part.

5. The spindle motor of claim 4, wherein the burr generation suppression part is formed in an upper portion of the outer peripheral surface of the shaft bonded to the press-fitted part.
